(19) United States
(12) Patent Application Publication
(10) Pub. No.: US 2021/0238797 A1
(43) Pub. Date: Aug. 5, 2021

(54) METHOD OF MAKING FIBER COMPRISING METAL NANOPARTICLES

(71) Applicant: Tripod Nano Technology Corporation, Taoyuan City (TW)

(72) Inventors: LIN LU, Taoyuan City (TW); CHUN-LUN CHIU, Taoyuan City (TW); Chung-Jung HUNG, Taoyuan City (TW); HSIN-CHANG HUANG, Taoyuan City (TW); Meng-Hsiu CHIH, Taoyuan City (TW); Cheng-Ding Wang, Taoyuan City (TW); MENG-YI BAI, Taoyuan City (TW)

(21) Appl. No.: 16/847,965

(22) Filed: Apr. 14, 2020

(30) Foreign Application Priority Data
Jan. 30, 2020 (TW) 109102790

(51) Int. Cl. D06M 11/83

(52) U.S. Cl. CPC D06M 11/83; B82Y 30/00

(57) ABSTRACT

Provided is a method of making a fiber comprising metal nanoparticles. The method includes steps of: Step (A): providing a fiber and a metal salt aqueous solution comprising first metal ions; Step (B): making the metal salt aqueous solution contact the fiber to form a fiber containing the first metal ions; and Step (C): contacting the fiber containing the first metal ions with a second metal, and performing a reduction reaction of the first metal ions to obtain the fiber comprising metal nanoparticles, wherein the fiber comprising metal nanoparticles comprises first metal nanoparticles from a reduction of the first metal ions; wherein a standard reduction potential of the first metal ions is greater than a standard reduction potential of an ionic state of the second metal, and a difference therebetween ranges from 0.4 V to 4.0 V.

### CROSS-REFERENCE TO RELATED APPLICATION

Pursuant to 35 U.S.C. § 119(a), this application claims the benefit of the priority to Taiwan Patent Application No. 109102790 filed on Jan. 30, 2020. The content of the prior application is incorporated herein by its entirety.

### BACKGROUND

### 1. Field of the Disclosure

The present invention relates to a method of making a fiber comprising a metal, more particular to a method of making a fiber comprising metal nanoparticles.

### 2. Description of the Prior Arts

Textiles are quite common daily necessities, such as clothing, towels, face masks, wet wipes and facial masks, which need to be in contact with users. With an advance in living standards and a strengthening of health awareness, functional textiles with an anti-bacterial, a mildew-proof, or an anti-odor function have received more attention, and therefore relevant researches also have entered a high-speed development stage.

In the traditional manufacturing process, organic anti-bacterial agents are usually applied to the fiber surface; however, some of said organic anti-bacterial agents may induce problems such as generation of toxic substances, poor heat resistance, fast decomposition, volatile, or drug resistance to microorganisms. Therefore, some methods using inorganic anti-bacterial agents with low toxicity, good heat resistance, and little drug resistance have been proposed successively. In general, inorganic anti-bacterial agents are mainly composed of metal materials such as silver, copper and gold.

There are several conventional methods for making functional fibers containing metal materials. For example, a metal material can be mixed with an adhesive and then applied directly to fiber surfaces to obtain anti-bacterial fibers. Nevertheless, since an adhesive ability of the adhesive decreases as time goes by, the content of metal material on the fiber surfaces will gradually decrease, and then the anti-bacterial effect of the fibers will also decrease. Besides, another method is forming a metal plating layer on fiber surfaces by conducting an electroplating in an electrolytic solution under an external electric field. However, this method not only produces industrial wastewater pollution but also has a strict restriction on the kinds of metal components. To overcome the problem, some researches have been proposed. For example, US Patent Application Publication No. 2013/0082425 discloses a method of making metal-coated polymer nano-fibers. The method comprises the steps of: electro-spinning a polymer solution to form polymer nano-fibers with epoxy rings on a surface thereof; contacting the electrospun polymer nano-fibers with a reducing agent, thereby obtaining a reducing agent modified polymer nano-fibers; and reacting the reducing agent modified polymer nano-fibers with a metal salt solution in alkaline media to obtain metal-coated polymer nano-fibers. Although the method can avoid the production of electroplating industrial wastewater and the metal and fiber have a high binding force, the method must use expensive equipment and specific materials as fibers, and also easily causes discoloration of the fibers, resulting in limited application.

In addition, Taiwan Utility Model Patent M569345 discloses a cloth with metal particles, which is coated with silver or copper metal particles on the surface of each fiber by sputtering; however, although the method can avoid production of electroplating industrial wastewater, it still requires expensive equipment and may cause a problem of uneven plating.

Furthermore, Taiwan Invention Patent 1606157 discloses a fiber masterbatch and a method of making the same; first, metal powders are coated with a dispersant uniformly, and then the coated metal powders are kneaded with a polymer matrix to form a fiber masterbatch; after that, the fiber masterbatch is made into fiber threads. However, the metal powders may be buried inside the fiber thread, or the dispersant coated on the surface of the metal powders may not completely melt, so the metal powders will not be exposed, thereby causing a significant reduction in antibacterial effect.

None of the above-mentioned conventional methods can conveniently and efficiently obtain fibers comprising metal nanoparticles, and there are many disadvantages such as expensive equipment, large energy consumption, and harmfulness to the environment, which are not conducive to mass production.

### SUMMARY OF THE DISCLOSURE

In view that the conventional method cannot make a fiber comprising metal nanoparticles safely and efficiently, an objective of the instant disclosure is to avoid using expensive equipment in the process and thus it is beneficial for mass production and has the higher potential for commercial implementation.

Another objective of the instant disclosure is to provide a method of making a fiber comprising metal nanoparticles, and the method has advantages of low energy consumption and environment-friendliness.

Another objective of the instant disclosure is to provide a method of making a fiber comprising metal nanoparticles, and the method has advantages of simplicity, time-effectiveness, and cost-effectiveness.

Another objective of the instant disclosure is to provide a method of making a fiber comprising metal nanoparticles, and in the obtained fiber comprising metal nanoparticles, the metal nanoparticles have a strong binding to the fibers.

To achieve the foresaid objectives, the instant disclosure provides a method of making a fiber comprising metal nanoparticles including Step (A) to Step (C). In Step (A), a fiber and a metal salt aqueous solution comprising first metal ions are provided. In Step (B), the metal salt aqueous solution is in contact with the fiber to form a fiber containing the first metal ions. In Step (C), the fiber containing the first metal ions is in contact with a second metal, and a reduction reaction of the first metal ions is performed to obtain the fiber comprising metal nanoparticles, wherein the fiber comprising metal nanoparticles comprises first metal nanoparticles from a reduction of the first metal ions; wherein a standard reduction potential of the first metal ions is greater than a standard reduction potential of an ionic state of the second metal, and a difference between the standard reduction potential of the first metal ions and the standard reduction potential of the ionic state of the second metal ranges from 0.4 volts (V) to 4.0 V.

Since the fiber has negative charges (δ⁻) on its surface and based on the fundamental principle of charge interaction “opposite charges attract”, the negative charges on the fiber surfaces will attract positive charges of the first metal ions in the metal salt aqueous solution when the fiber is in contact with the metal salt aqueous solution comprising the first metal ions. Moreover, since the standard reduction potential of the first metal ions is greater than the standard reduction potential of the ionic state(s) of the second metal, the first metal ions undergo a galvanic displacement reaction (i.e. reduction reaction) without an external electric field and are directly reduced to the first metal nanoparticles upon the surface of the fiber in-situ by contacting the fiber containing the first metal ions with the second metal. It can be seen that the instant disclosure is not necessary to sinter at a high temperature or to use expensive equipment to obtain fibers comprising metal nanoparticles. Therefore, the instant disclosure can effectively simplify the process, and have the advantages of simplicity, safety, low energy consumption, low cost, environment-friendliness and high yield. In addition, because the first metal ions are directly reduced to the first metal nanoparticles upon the surface of the fiber, and the surface of the first metal nanoparticles is with slightly positive charges (δ⁺), the first metal nanoparticles can be uniformly embedded on the surface of the fiber having slightly negative charges by electrostatic attraction therebetween. As a result, the first metal nanoparticles can have a strong bonding with the fiber surface without any additional adhesive.

In accordance with the instant disclosure, as long as the difference in the standard reduction potential between the first metal ions and the ionic state of the second metal is greater than 0 V, a galvanic displacement reaction can occur. Preferably, the first metal ions comprise gold ions, platinum ions, silver ions (Ag⁺), copper ions, iron ions, zinc ions (Zn²⁺) or titanium ions, but it is not limited thereto. Specifically, the gold ions may be trivalent gold ions (Au³⁺) or monovalent gold ions (Au⁺); the platinum ions may be tetravalent platinum ions (Pt⁴⁺) or divalent platinum ions (Pt²⁺); the copper ions may be divalent copper ions (Cu²⁺); the iron ions may be divalent iron ions (Fe²⁺) or trivalent iron ions (Fe³⁺); the titanium ions may be tetravalent titanium ions (Ti⁴⁺) or trivalent titanium ions (Ti³⁺). For example, the first metal ions may be from HAuCl₄, H₂PtCl₆.(H₂O)₆), AgNO₃, Cu(NO₃)₂, CuCl₂, FeCl₂, FeCl₃, ZnCl₂, TiCl₃, or TiCl₄.

In certain embodiments, the first metal ions may comprise a same kind of metal but have different oxidation states. For example, the first metal ions comprise tetravalent platinum ions and divalent platinum ions, but it is not limited thereto.

Preferably, the second metal may comprise magnesium metal (Mg), aluminum metal (Al), manganese metal (Mn), titanium metal (Ti), zinc metal (Zn), iron metal (Fe), nickel metal (Ni), tin metal (Sn), copper metal (Cu) or silver metal (Ag).

In general, Galvanic Series of metals is in the order from large to small as follows: Au, Pt, Ag, Cu, hydrogen (H), Sn, Ni, Fe, Zn, Mn, Ti, Al, and Mg. The order of Galvanic Series is same to an order of reduction potential of each element. As the reduction potential of a metal is higher than the reduction potential of H, its reduction potential is marked with a positive sign. The larger value of the positive number, the lower the activity of the metal and the less likely it is to be oxidized in nature. Conversely, as the reduction potential of a metal is lower than the reduction potential of H, its reduction potential is marked with a negative sign. The larger value of the negative number, the higher the activity of the metal, and the more likely it is to lose electrons and be oxidized in nature. Preferably, a difference in standard reduction potential between the first metal ions and an ionic state of the second metal ranges from 0.46 V to 3.88 V.

Preferably, in the metal salt aqueous solution, a concentration of the first metal ions ranges from 1 μg/L (also expressed as ppb) to 90 g/L. More preferably, the concentration of the first metal ions ranges from 0.05 g/L to 80 g/L. For example, in some embodiments, the concentration of the first metal ions may be 1 mg/L (also expressed as ppm) to 200 mg/L. In another embodiments, the concentration of the first metal ions may be 0.5 g/L to 72 g/L.

In accordance with the instant disclosure, in Step (B), the step of making the metal salt aqueous solution contact the fiber may be performed by a dipping method, a coating method, a spraying method or an automatic roll-pulling method, but it is not limited thereto. Preferably, said step is performed by the dipping method. Preferably, a contact time ranges from 0.1 second to 24 hours.

In accordance with the instant disclosure, in Step (C), a method for the second metal contacting the fiber containing the first metal ions may comprise an overlapping method or an automatic roll-pulling method, but it is not limited thereto. Preferably, the second metal may be in a form of a foil, a rod or a roller, but it is not limited thereto.

Preferably, in Step (C), a reaction time of the reduction reaction (i.e. a contact time for the second metal contacting the fiber containing the first metal ions) ranges from 0.1 second to 24 hours. More preferably, the reaction time of the reduction reaction ranges from 1 second to 12 hours.

Preferably, Step (C) may comprise Steps (c1) and (c2). In Step (c1), the fiber containing the first metal ions is in contact with the second metal, and the reduction reaction of the first metal ions is performed to obtain a first composite fiber, wherein the first composite fiber comprises the first metal nanoparticles; and in Step (c2), the first composite fiber is left to stand for 0.1 hour to 72 hours, so as to obtain the fiber comprising metal nanoparticles. In order to reduce the possibility of metal nanoparticles being oxidized, a temperature of Step (c2) ranges from 0° C. to 120° C. In some embodiments, the first composite fiber may be statically placed in an oven, but it is not limited thereto, and a temperature in the oven ranges from 60° C. to 120° C.

In some embodiments, Step (c1) may comprise Steps (c1-1) and (c1-2). In Step (c1-1), the fiber containing the first metal ions is in contact with the second metal, and the reduction reaction of the first metal ions is performed to produce a mixture having second metal ions, an unreacted second metal, and the first composite fiber comprising the first metal nanoparticles; and in Step (c1-2), the unreacted second metal and the second metal ions from the mixture are removed, so as to obtain the first composite fiber. Preferably, in Step (c1-2), the first composite fiber may be washed with water, wherein the water is distilled water, and preferably, the water is deionized water. Because most fibers are made of highly hydrophobic materials, washing with water not only removes residual ions (such as metal ions from an oxidation of a second metal, unreacted first metal ions and counterions for the first metal ions) but also ensures that the first metal nanoparticles on the fiber surface will not easily detach from the fiber surface during the cleaning process. Preferably, the cleaning process may further include cleaning the first composite fiber by an ultrasonicator, and the cleaning process may repeat multiple times, for example, 4 times or 5 times, but it is not limited thereto.

In some embodiments, the method of the present invention comprises repeating a cycle including Steps (A) to (C) for at least one time, i.e., the first composite fiber can be used as a raw material (corresponding to the fiber in Step (A)) to perform a repeated cycle operation. Specifically, Step (C) comprises Step (c1), Step (c1-b) and Step (c1-c). In Step (c1), the fiber containing the first metal ions is in contact with the second metal, and the reduction reaction of the first metal ions is performed to obtain a first composite fiber, wherein the first composite fiber comprises the first metal nanoparticles. In Step (c1-b) (corresponding to Step (B)), a metal salt aqueous solution containing third metal ions is in contact with the first composite fiber to form a second composite fiber which contains the third metal ions, wherein the third metal ions are different from the first metal ions; and in Step (c1-c) (corresponding to Step (C)), the second composite fiber is in contact with a fourth metal, and a reduction reaction of the third metal ions is performed to obtain the fiber comprising metal nanoparticles, wherein the fiber comprising metal nanoparticles comprises the first metal nanoparticles from the reduction of the first metal ions and third metal nanoparticles from a reduction of the third metal ions; wherein a standard reduction potential of the third metal ions is greater than a standard reduction potential of an ionic state of the fourth metal, and a difference between the standard reduction potential of the third metal ions and the standard reduction potential of the ionic state of the fourth metal ranges from 0.4 V to 4.0 V; and the standard reduction potential of the first metal ions is greater than the standard reduction potential of the ionic state of the fourth metal.

Preferably, the third metal ions comprise gold ions, platinum ions, silver ions, copper ions, iron ions, zinc ions or titanium ions, but it is not limited thereto.

Preferably, the standard reduction potential of the first metal ions is greater than the standard reduction potential of the third metal ions.

In some embodiments, the fourth metal may be the same as the second metal in Step (c1). In another embodiments, the fourth metal may be different from the second metal in Step (c1).

Preferably, the fourth metal may comprise magnesium metal (Mg), aluminum metal (Al), manganese metal (Mn), titanium metal (Ti), zinc metal (Zn), iron metal (Fe), nickel metal (Ni), tin metal (Sn), copper metal (Cu) or silver metal (Ag), but it is not limited thereto.

In order to make the process simper and further reduce per unit production cost for increasing the competitive advantage, preferably, the fourth metal in the Step (c1-c) is the same as the second metal in the Step (c1). Preferably, in the metal salt aqueous solution containing third metal ions, a concentration of the third metal ions ranges from 1 μg/L to 100 g/L. More preferably, the concentration of the third metal ions ranges from 0.05 g/L to 80 g/L. For example, in some embodiments, the concentration of the third metal ions may be 0.1 g/L to 40 g/L.

In accordance with the instant disclosure, a kind of the fiber is not specifically limited. Preferably, the fiber may comprise synthetic fibers such as Rayon, cellulose acetate, Nylon, Tetoron, polyacrylonitrile (PAN, also called Orlon), polyethylene terephthalate (PET, also called Dacron), inorganic fibers such as carbides or natural fibers such as bamboo, cotton, linen, silk, and wool, but it is not limited thereto. More preferably, the fiber may be a Rayon fiber, a cellulose acetate fiber, a Tetoron fiber, a PAN fiber, a PET fiber, a polyester fiber or a bamboo fiber. In some case, the fiber may further comprise some material such as an activated carbon, but it is not limited thereto.

In accordance with the instant disclosure, the fiber can be woven to form a fabric layer including, but not limited to knitting, circular weaving, plain weaving or weaving.

In order to make the galvanic displacement reaction proceed more smoothly and the metal nanoparticles effectively and uniformly combine with the surface of the fiber, preferably, the area of the second metal is equal to the area of the fabric layer.

In order to ensure that the first metal ions which are not reduced by the second metal are reduced thoroughly, preferably, the metal salt aqueous solution may further comprise a reducing agent, but it is not limited thereto. In light of users' health and safety of the natural environment, the reducing agent may comprise a compound with an aldehyde group or a hydroxy group, but it is not limited thereto. In addition, the reducing agent may be a low-toxic or non-toxic reducing agent such as citric acid, glycerol, lactic acid, polyactic acid, ascorbic acid, oxalic acid, glucose, or any combination thereof. Preferably, based on a total weight of the metal salt aqueous solution, a content of the reducing agent ranges from 0.1 wt % to 10 wt %.

In accordance with the instant disclosure, the first metal nanoparticles of the fiber comprising metal nanoparticles have an average size ranging from 1 nm to 100 nm. Preferably, said first metal nanoparticles have an average size ranging from 10 nm to 100 nm. Similarly, the third metal nanoparticles of the fiber comprising metal nanoparticles have an average size ranging from 1 nm to 100 nm. Preferably, said third metal nanoparticles have an average size ranging from 10 nm to 100 nm.

In accordance with the instant disclosure, the first metal nanoparticles are in an amount of 10 μs to 100 mg per square centimeter (cm²) of the surface area of the fiber. Preferably, the first metal nanoparticles are in an amount of 0.5 mg to 100 mg per square centimeter of the surface area of the fiber. In certain embodiments, a total content of the first and third metal nanoparticles ranges from 0.1 mg to 100 mg per square centimeter of the surface area of the fiber. Preferably, the total content of the first and third metal nanoparticles ranges from 1.0 mg to 100 mg per square centimeter of the surface area of the fiber.

In accordance with the instant disclosure, the first metal nanoparticles are in an amount of 10 μg to 100 mg per gram of the fiber. Preferably, the first metal nanoparticles are in an amount of 20 μg to 40 mg per gram of the fiber. In certain embodiments, a total content of the first and third metal nanoparticles ranges from 10 μg to 100 mg per gram of the fiber. Preferably, the total content of the first and third metal nanoparticles ranges from 20 μg to 50 mg per gram of the fiber.

The fiber comprising metal nanoparticles of the present invention can be applied to various fabrics; for example, clothing, especially sports clothing or astronaut clothing, medical clothing, nursing practitioner work clothes, long-term care patient clothing; masks, towels, wet tissues, face masks, or gauze, but it is not limited thereto.

In this specification, where a range of values is provided, it is understood that each intervening value, to the tenth of the unit of the lower limit unless the context clearly dictates otherwise, between the upper and lower limits of that range and any other stated or intervening value in that stated range, is encompassed within the invention. The upper and lower limits of these smaller ranges may independently be included in the smaller ranges, and are also encompassed within the invention, subject to any specifically excluded limit in the stated range. Where the stated range includes one or both of the limits, ranges excluding either or both of those included limits are also included in the invention.

Unless defined otherwise, all technical and scientific terms used herein have the same meaning as commonly understood by one of ordinary skill in the art to which this invention pertains. Although any methods and materials similar or equivalent to those described herein can be used in the practice or testing of the present invention, the preferred methods and materials are now described. All publications mentioned hereunder are incorporated herein by reference. Unless mentioned otherwise, the techniques employed herein are standard methodologies well known to one of ordinary skill in the art.

It must be noted that as used herein and in the appended claims, the singular forms “a,” “an,” and “the” include plural referents unless the context clearly dictates otherwise.

Other objectives, advantages and novel features of the disclosure will become more apparent from the following detailed description when taken in conjunction with the accompanying drawings.

### BRIEF DESCRIPTION OF THE DRAWINGS

FIG. 1A is a SEM image of the fiber comprising metal nanoparticles obtained in Example 1.

FIG. 1B is an EDS spectrum of the fiber comprising metal nanoparticles obtained in Example 1.

FIG. 2A is a SEM image of the fiber comprising metal nanoparticles obtained in Example 2.

FIG. 2B is an EDS spectrum of the fiber comprising metal nanoparticles obtained in Example 2.

FIG. 3A is a SEM image of the fiber comprising metal nanoparticles obtained in Example 3.

FIG. 3B is an EDS spectrum of the fiber comprising metal nanoparticles obtained in Example 3.

FIG. 4A is a SEM image of the fiber comprising metal nanoparticles obtained in Example 4.

FIG. 4B is an EDS spectrum of the fiber comprising metal nanoparticles obtained in Example 4.

FIG. 5A is a SEM image of the fiber comprising metal nanoparticles obtained in Example 5.

FIG. 5B is an EDS spectrum of the fiber comprising metal nanoparticles obtained in Example 5.

FIG. 6A is a SEM image of the fiber comprising metal nanoparticles obtained in Example 7.

FIG. 6B is an EDS spectrum of the fiber comprising metal nanoparticles obtained in Example 7.

FIG. 7 is an EDS spectrum of the fiber comprising metal nanoparticles obtained in Example 8.

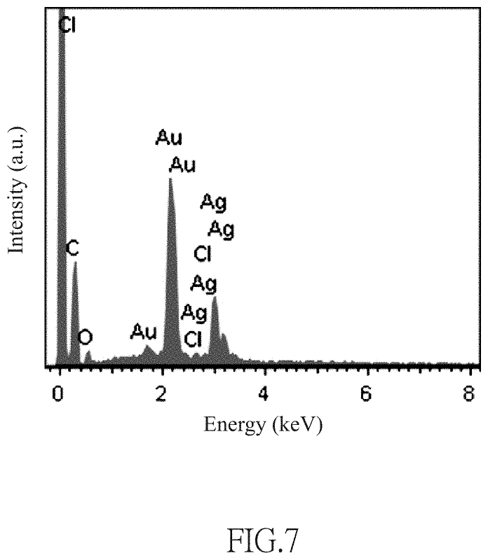

### DETAILED DESCRIPTION OF THE DISCLOSURE

Hereinafter, one skilled in the art can easily realize the advantages and effects of the instant disclosure from the following examples. Therefore, it should be understood that the descriptions proposed herein are just preferable examples for the purpose of illustrations only, not intended to limit the scope of the disclosure. Various modifications and variations could be made in order to practice or apply the instant disclosure without departing from the spirit and scope of the disclosure.

In the following Examples, all the reagents were reagent grade purchased from Acros Organics and were used without further purification.

Water is distilled or deionized for use as a solvent.

Instruments:

1. Inductively couple plasma optical emission spectrometry (ICP-OES): Agilent 5100 manufactured by Agilent Technologies; and

2. Scanning Electron Microscope (SEM): S-3000N manufactured by Hitachi, Ltd.

### Example 1

0.34 g of silver nitrate (AgNO₃) was dissolved in 20 mL of ultrapure water and stirred continuously for 10 minutes to obtain 0.1 M AgNO_{3(aq)}. Subsequently, at room temperature (25° C.), a Tetoron fabric was dipped in 6.73 mL of the 0.1 M AgNO_{3(aq)} for 2 minutes. The Tetoron fabric had an area of 5 cm² and a weight of 1.92 g, and it was made by Tetoron fibers with an average diameter of 10.8 μm. During the dipping process, the Tetoron fibers of the Tetoron fabric were in contact with the 0.1 M AgNO_{3(aq)} to form fibers containing silver ions, thereby obtaining Tetoron fabric containing silver ions.

Then, the Tetoron fabric containing silver ions was covered by a zinc metal foil with an area of 5 cm² and a weight of 1.6 g for 15 minutes, so the silver ions of the Tetoron fabric underwent a reduction reaction on the surface of the Tetoron fabric.

After completion of the reduction reaction, the remaining zinc metal foil which was unreacted to become zinc ions was removed, and then the obtained Tetoron fabric was repeatedly washed with ultrapure water by an ultrasonicator for 5 times to ensure the remaining ions on the fiber surface (such as unreacted silver ions, zinc ions from the reaction, and nitrate ions) were removed.

After that, the Tetoron fabric was placed in an oven set at 90° C. and dried for 24 hours, so as to obtain a Fabric A which contained fibers comprising metal nanoparticles, and the metal nanoparticles were silver nanoparticles.

### Example 2

10 mg of chloroauric acid (HAuCl₄) was dissolved in 99.99 g of ultrapure water and stirred continuously for 10 minutes to obtain 0.01 wt % HAuCl_{4(aq)}. Subsequently, at room temperature (25° C.), an activated carbon nonwoven fabric was dipped in 50 mL of the 0.01 wt % HAuCl_{4(aq)} for 30 seconds. The activated carbon nonwoven fabric had an area of 25 cm² and a weight of 0.38 g, and it was made by cellulose acetate fibers with an average diameter of 16.3 μm. During the dipping process, the cellulose acetate fibers of the activated carbon nonwoven fabric were in contact with the 0.01 wt % HAuCl_{4(aq)} to form cellulose acetate fibers containing gold ions, thereby obtaining an activated carbon nonwoven fabric containing gold ions.

Then, both upper and lower surfaces of the activated carbon nonwoven fabric containing gold ions were respectively covered by two sheets of magnesium metal foils each with an area of 25 cm² and a weight of 21 g for 15 minutes, so the gold ions of the activated carbon nonwoven fabric underwent a reduction reaction on the surface of the activated carbon nonwoven fabric.

After completion of the reduction reaction, the remaining magnesium metal foils which were unreacted to become magnesium ions (Mg²⁺) were removed, and then the obtained activated carbon nonwoven fabric was repeatedly washed with ultrapure water by an ultrasonicator for 5 times to ensure the remaining ions on the fiber surface were removed.

After that, the obtained activated carbon nonwoven fabric was placed in an oven set at 90° C. and dried for 24 hours, so as to obtain a composite activated carbon nonwoven fabric which contained gold nanoparticles.

100 mg of AgNO₃ was dissolved in 99.9 g of ultrapure water and stirred continuously for 10 minutes to obtain 0.1 wt % AgNO_{3(aq)}. Subsequently, at room temperature (25° C.), said composite activated carbon nonwoven fabric was dipped in 50 mL of the 0.1 wt % AgNO_{3(aq)} for 30 seconds. During the dipping process, the cellulose acetate fibers of said composite activated carbon nonwoven fabric were in contact with the 0.1 wt % AgNO_{3(aq)} to form cellulose acetate fibers containing silver ions, thereby obtaining a composite activated carbon nonwoven fabric containing silver ions.

Then, both upper and lower surfaces of the composite activated carbon nonwoven fabric were respectively covered by two sheets of magnesium metal foils each with an area of 25 cm² and a weight of 21 g for 15 minutes, so the silver ions of the composite activated carbon nonwoven fabric underwent a reduction reaction on the surface of the composite activated carbon nonwoven fabric.

After completion of the reduction reaction, the remaining magnesium metal foil which was unreacted to become Mg²⁺ was removed, and then the obtained composite activated carbon nonwoven fabric was repeatedly washed with ultrapure water by an ultrasonicator for 5 times to ensure the remaining ions on the fiber surface were removed.

After that, said composite activated carbon nonwoven fabric was placed in an oven set at 90° C. and dried for 24 hours, so as to obtain a Fabric B which contained fibers comprising metal nanoparticles, and the metal nanoparticles were gold and silver nanoparticles.

### Example 3

15.7 g of gold(III) chloride trihydrate (HAuCl₄.3H₂O) was dissolved in 200 mL of ultrapure water and stirred continuously for 10 minutes to obtain 0.2 M HAuCl_{4(aq)}. Subsequently, at room temperature (25° C.), 200 mL of the 0.2 M HAuCl_{4(aq)} was uniformly sprayed onto a nonwoven fabric. The nonwoven fabric had an area of 400 cm² and a weight of 6.1 g, and it was made by PAN fibers with an average diameter of 10.1 μm. During the spraying process, the PAN fibers of the nonwoven fabric were in contact with the HAuCl_{4(aq)} to form PAN fibers containing gold ions, thereby obtaining a nonwoven fabric containing gold ions.

Then, both upper and lower surfaces of the nonwoven fabric containing gold ions were respectively covered by two sheets of aluminum metal foils each with an area of 400 cm² and a weight of 27 g for 15 minutes, so the gold ions of the nonwoven fabric underwent a reduction reaction on the surface of the nonwoven fabric.

After completion of the reduction reaction, the remaining aluminum metal foils which were unreacted to become aluminum ions (Al³⁺) were removed, and then the obtained nonwoven fabric was repeatedly washed with ultrapure water by an ultrasonicator for 5 times to ensure the remaining ions on the fiber surface were removed.

After that, the obtained nonwoven fabric was placed in an oven set at 90° C. and dried for 24 hours, so as to obtain a composite nonwoven fabric which contained gold nanoparticles. 4.24 mg of AgNO₃ was dissolved in 10 mL of ultrapure water and stirred continuously for 10 minutes to obtain 2.5 mM AgNO_{3(aq)}. Subsequently, at room temperature (25° C.), 10 mL of the 2.5 mM AgNO_{3(aq)} was uniformly sprayed onto said composite nonwoven fabric. During the spraying process, the PAN fibers of said composite nonwoven fabric were in contact with the 2.5 mM AgNO_{3(aq)} to form PAN fibers containing silver ions, thereby obtaining a composite nonwoven fabric containing silver ions.

Then, both upper and lower surfaces of the composite nonwoven fabric were respectively covered by two sheets of aluminum metal foils each with an area of 400 cm² and a weight of 27 g for 15 minutes, so the silver ions of the composite nonwoven fabric underwent a reduction reaction on the surface of the composite nonwoven fabric.

After completion of the reduction reaction, the remaining aluminum metal foil which was unreacted to become Al³⁺ was removed, and then the obtained composite nonwoven fabric was repeatedly washed with ultrapure water by an ultrasonicator for 5 times to ensure the remaining ions on the fiber surface were removed.

After that, said composite nonwoven fabric was placed in an oven set at 90° C. and dried for 24 hours, so as to obtain a Fabric C which contained fibers comprising metal nanoparticles, and the metal nanoparticles were gold and silver nanoparticles.

### Example 4

0.34 g of AgNO₃ was dissolved in 20 mL of ultrapure water and stirred continuously for 10 minutes to obtain 0.1 M AgNO_{3(aq)}. Subsequently, at room temperature (25° C.), a moisture-wicking fabric was dipped in 1.5 mL of the 0.1 M AgNO_{3(aq)} for 2 minutes. The moisture-wicking fabric had an area of 30 cm² and a weight of 3.9 g, and it was made by PET fibers with an average diameter of 10.5 μm. During the dipping process, the PET fibers of the moisture-wicking fabric were in contact with the 0.1 M AgNO_{3(aq)} to form PET fibers containing silver ions, thereby obtaining moisture-wicking fabric containing silver ions.

Then, the moisture-wicking fabric containing silver ions was covered by a titanium metal foil with an area of 30 cm² and a weight of 3.3 g for 15 minutes, so the silver ions of the moisture-wicking fabric underwent a reduction reaction on the surface of the moisture-wicking fabric.

After completion of the reduction reaction, the remaining titanium metal foil which was unreacted to become titanium ions was removed, and then the obtained moisture-wicking fabric was repeatedly washed with ultrapure water by an ultrasonicator for 5 times to ensure the remaining ions on the fiber surface were removed.

After that, the moisture-wicking fabric was placed in an oven set at 90° C. and dried for 24 hours, so as to obtain a Fabric D which contained fibers comprising metal nanoparticles, and the metal nanoparticles were silver nanoparticles.

### Example 5

100 mg of chloroauric acid was dissolved in 99.99 g of pure water and stirred continuously for 10 minutes to obtain 0.1 wt % HAuCl_{4(aq)}. Subsequently, at room temperature (25° C.), an activated carbon nonwoven fabric was dipped in 50 mL of the 0.1 wt % HAuCl_{4(aq)} for 30 seconds. The activated carbon nonwoven fabric had an area of 25 cm² and a weight of 0.45 g, and it was made by Rayon fibers with an average diameter of 15.8 μm. During the dipping process, the Rayon fibers of the activated carbon nonwoven fabric were in contact with the 0.1 wt % HAuCl_{4(aq)} to form Rayon fibers containing gold ions, thereby obtaining an activated carbon nonwoven fabric containing gold ions.

Then, both upper and lower surfaces of the activated carbon nonwoven fabric containing gold ions were respectively covered by two sheets of copper metal foils each with an area of 25 cm² and a weight of 22.4 g for 15 minutes, so the gold ions of the activated carbon nonwoven fabric underwent a reduction reaction on the surface of the activated carbon nonwoven fabric.

After completion of the reduction reaction, the remaining copper metal foils which was unreacted to become copper ions were removed, and then the obtained activated carbon nonwoven fabric was repeatedly washed with ultrapure water by an ultrasonicator for 5 times to ensure the remaining ions on the fiber surface were removed.

After that, the obtained activated carbon nonwoven fabric was placed in an oven set at 90° C. and dried for 24 hours, so as to obtain a composite activated carbon nonwoven fabric which contained gold nanoparticles.

100 mg of AgNO₃ was dissolved in 99.9 g of ultrapure water and stirred continuously for 10 minutes to obtain 0.1 wt % AgNO_{3(aq)}. Subsequently, at room temperature (25° C.), said composite activated carbon nonwoven fabric was dipped in 50 mL of the 0.1 wt % AgNO_{3(aq)} for 30 seconds. During the dipping process, the Rayon fibers of said composite activated carbon nonwoven fabric were in contact with the 0.1 wt % AgNO_{3(aq)} to form Rayon fibers containing silver ions, thereby obtaining a composite activated carbon nonwoven fabric containing silver ions.

Then, both upper and lower surfaces of the composite activated carbon nonwoven fabric were respectively covered by two sheets of copper metal foils each with an area of 25 cm² and a weight of 22.4 g for 15 minutes, so the silver ions of the composite activated carbon nonwoven fabric underwent a reduction reaction on the surface of the composite activated carbon nonwoven fabric.

After completion of the reduction reaction, the remaining copper metal foil which was unreacted to become copper ions was removed, and then the obtained composite activated carbon nonwoven fabric was repeatedly washed with ultrapure water by an ultrasonicator for 5 times to ensure the remaining ions on the fiber surface were removed.

After that, said composite activated carbon nonwoven fabric was placed in an oven set at 90° C. and dried for 24 hours, so as to obtain a Fabric E which contained fibers comprising metal nanoparticles, and the metal nanoparticles were gold and silver nanoparticles.

### Example 6

0.34 g of AgNO₃ was dissolved in 20 mL of ultrapure water and stirred continuously for 10 minutes to obtain 0.1 M AgNO_{3(aq)}. Subsequently, at room temperature (25° C.), a nonwoven fabric which was set on an outer layer of the face mask was dipped in 2.25 mL of the 0.1 M AgNO_{3(aq)} for 2 minutes. The nonwoven fabric had an area of 9 cm² and a weight of 0.013 g, and it was made by PAN fibers with an average diameter of 16.1 μm. During the dipping process, the PAN fibers of the nonwoven fabric were in contact with the 0.1 M AgNO_{3(aq)} to form PAN fibers containing silver ions, thereby obtaining nonwoven fabric containing silver ions.

Then, the nonwoven fabric containing silver ions was covered by a tin metal foil with an area of 9 cm² and a weight of 5.2 g for 15 minutes, so the silver ions of the nonwoven fabric underwent a reduction reaction on the surface of the nonwoven fabric.

After completion of the reduction reaction, the remaining tin metal foil which was unreacted to become tin ions was removed, and then the obtained nonwoven fabric was repeatedly washed with ultrapure water by an ultrasonicator for 5 times to ensure the remaining ions on the fiber surface were removed.

After that, the nonwoven fabric was placed in an oven set at 90° C. and dried for 24 hours, so as to obtain a Fabric F which contained fibers comprising metal nanoparticles, and the metal nanoparticles were silver nanoparticles.

### Example 7

0.34 g of AgNO₃ was dissolved in 20 mL of ultrapure water and stirred continuously for 10 minutes to obtain 0.1 M AgNO_{3(aq)}. Subsequently, at room temperature (25° C.), a gauze was dipped in 6.25 mL of the 0.1 M AgNO_{3(aq)} for 2 minutes. The gauze had an area of 25 cm² and a weight of 0.4 g, and it was made by bamboo fibers with an average diameter of 11.9 μm. During the dipping process, the bamboo fibers of the gauze were in contact with the 0.1 M AgNO_{3(aq)} to form bamboo fibers containing silver ions, thereby obtaining gauze containing silver ions.

Then, the gauze containing silver ions was covered by a nickel metal foil with an area of 25 cm² and a weight of 22.25 g for 15 minutes, so the silver ions of the gauze underwent a reduction reaction on the surface of the gauze.

After completion of the reduction reaction, the remaining nickel metal foil which was unreacted to become nickel ions was removed, and then the obtained gauze was repeatedly washed with ultrapure water by an ultrasonicator for 5 times to ensure the remaining ions on the fiber surface were removed.

After that, the gauze was placed in an oven set at 90° C. and dried for 24 hours, so as to obtain a Fabric G which contained fibers comprising metal nanoparticles, and the metal nanoparticles were silver nanoparticles.

### Example 8

100 mg of chloroauric acid was dissolved in 99.99 g of pure water and stirred continuously for 10 minutes to obtain 0.1 wt % HAuCl_{4(aq)}. Subsequently, at room temperature (25° C.), a gauze was dipped in 10 mL of the 0.1 wt % HAuCl_{4(aq)} for 2 minutes. The gauze had an area of 25 cm² and a weight of 0.4 g, and it was made by bamboo fibers with an average diameter of 11.9 During the dipping process, the bamboo fibers of the gauze were in contact with the 0.1 wt % HAuCl_{4(aq)} to form bamboo fibers containing gold ions, thereby obtaining a gauze containing gold ions.

Then, the gauze containing gold ions was covered by a copper metal foil with an area of 25 cm² and a weight of 22.4 g for 15 minutes, so the gold ions of the gauze underwent a reduction reaction on the surface of the gauze.

After completion of the reduction reaction, the remaining copper metal foils which were unreacted to become copper ions were removed, and then the obtained gauze was repeatedly washed with ultrapure water by an ultrasonicator for 5 times to ensure the remaining ions on the fiber surface were removed.

After that, the obtained gauze was placed in an oven set at 90° C. and dried for 24 hours, so as to obtain a composite gauze which contained gold nanoparticles.

0.34 g of AgNO₃ was dissolved in 20 mL of ultrapure water and stirred continuously for 10 minutes to obtain 0.1 M AgNO_{3(aq)}. Subsequently, at room temperature (25° C.), said composite gauze was dipped in 5 mL of the 0.1 M AgNO_{3(aq)} for 2 minutes. During the dipping process, the bamboo fibers of said composite gauze were in contact with the 0.1 M AgNO_{3(aq)} to form bamboo fibers containing silver ions, thereby obtaining a composite gauze containing silver ions.

Then, the composite gauze was covered by a copper metal foil with an area of 25 cm² and a weight of 22.4 g for 15 minutes, so the silver ions of the composite gauze underwent a reduction reaction on the surface of the composite gauze.

After completion of the reduction reaction, the remaining copper metal foil which was unreacted to become copper ions was removed, and then the obtained composite gauze was repeatedly washed with ultrapure water by an ultrasonicator for 5 times to ensure the remaining ions on the fiber surface were removed.

After that, said composite gauze was placed in an oven set at 90° C. and dried for 24 hours, so as to obtain a Fabric H which contained fibers comprising metal nanoparticles, and the metal nanoparticles were gold and silver nanoparticles.

### Example 9

0.34 g of AgNO₃ was dissolved in 20 mL of ultrapure water and stirred continuously for 10 minutes to obtain 0.1 M AgNO_{3(aq)}. Subsequently, at room temperature (25° C.), an electrostatic fabric was dipped in 10 mL of the 0.1 M AgNO_{3(aq)} for 2 minutes. The electrostatic fabric had an area of 9 cm² and a weight of 0.02 g, and it was made by polyester fibers with an average diameter of 10.8 μm. During the dipping process, the polyester fibers of the electrostatic fabric were in contact with the 0.1 M AgNO_{3(aq)} to form polyester fibers containing silver ions, thereby obtaining electrostatic fabric containing silver ions.

Then, the electrostatic fabric containing silver ions was covered by a zinc metal foil with an area of 9 cm² and a weight of 2.9 g for 15 minutes, so the silver ions of the electrostatic fabric underwent a reduction reaction on the surface of the electrostatic fabric.

After completion of the reduction reaction, the remaining zinc metal foil which was unreacted to become zinc ions was removed, and then the obtained electrostatic fabric was repeatedly washed with ultrapure water by an ultrasonicator for 5 times to ensure the remaining ions on the fiber surface were removed.

After that, the electrostatic fabric was placed in an oven set at 90° C. and dried for 24 hours, so as to obtain a Fabric I which contained fibers comprising metal nanoparticles, and the metal nanoparticles were silver nanoparticles.

Analysis of Characteristics of Fabrics Containing Fibers Comprising Metal Nanoparticles:

Fabrics A to I were sequentially analyzed by test methods described below. In order to ensure the experimental significance of the characteristic analysis, Fabrics A to I were each analyzed by the same test method. Therefore, it can be understood that the difference in characteristics of each of Fabrics A to I was mainly caused by the difference in fibers comprising metal nanoparticles of each of the fabrics.

Analysis 1:

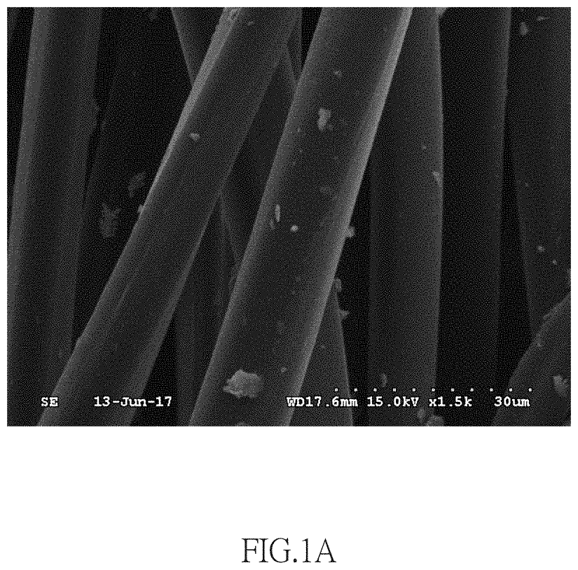

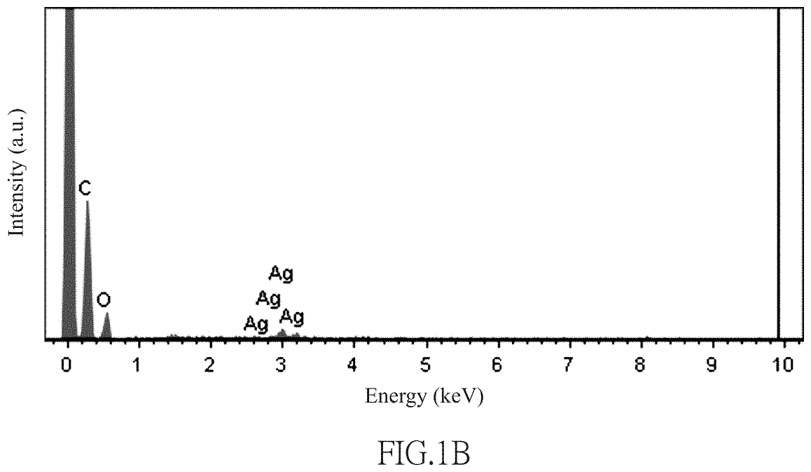

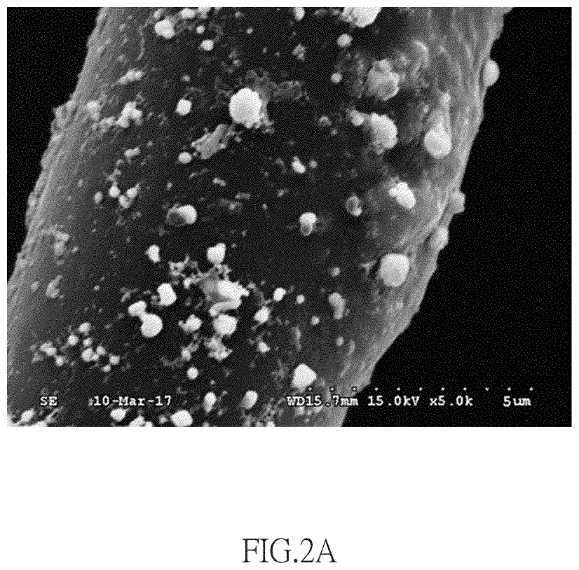

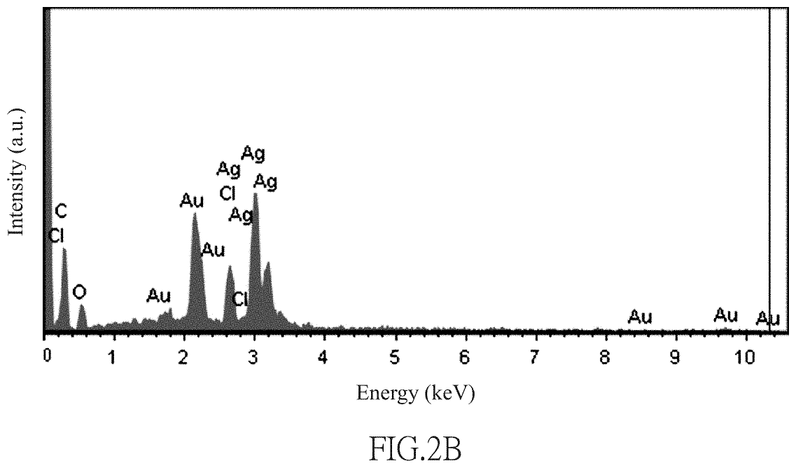

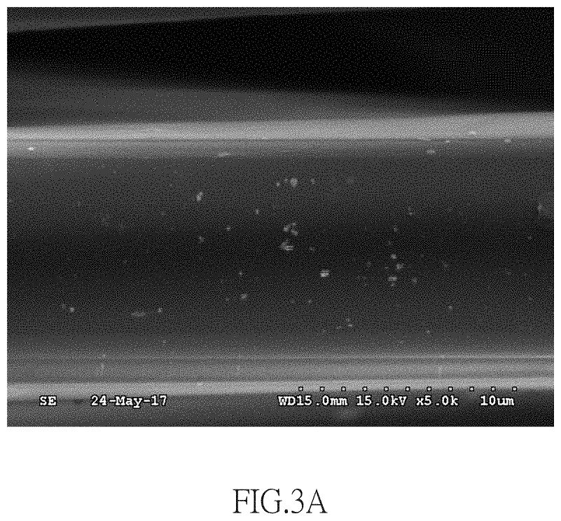

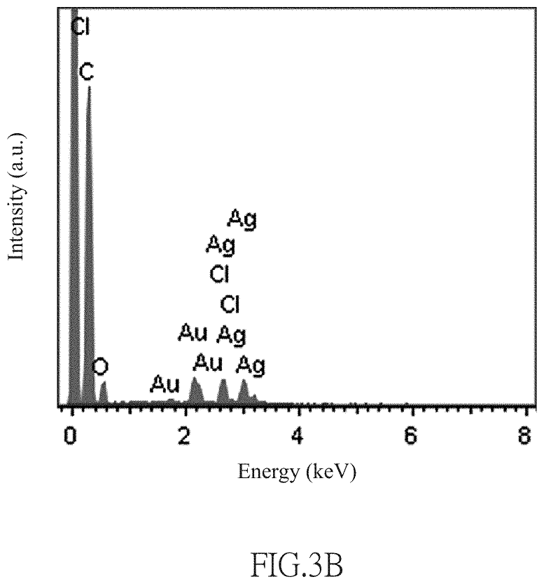

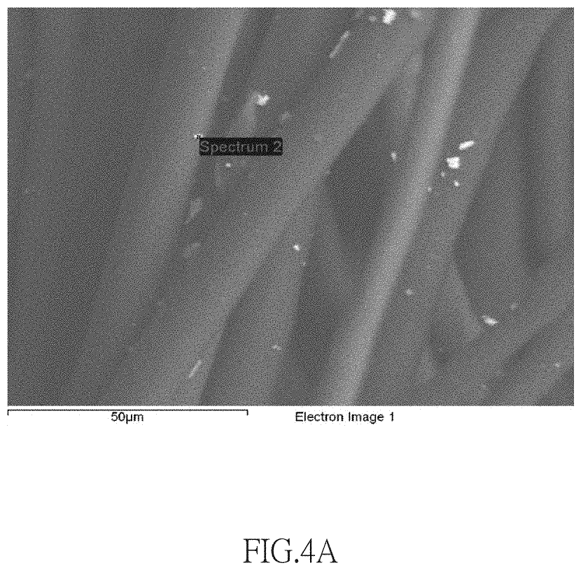

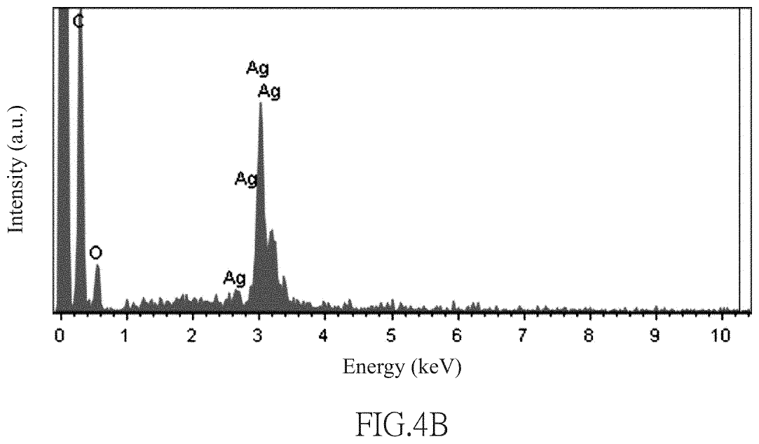

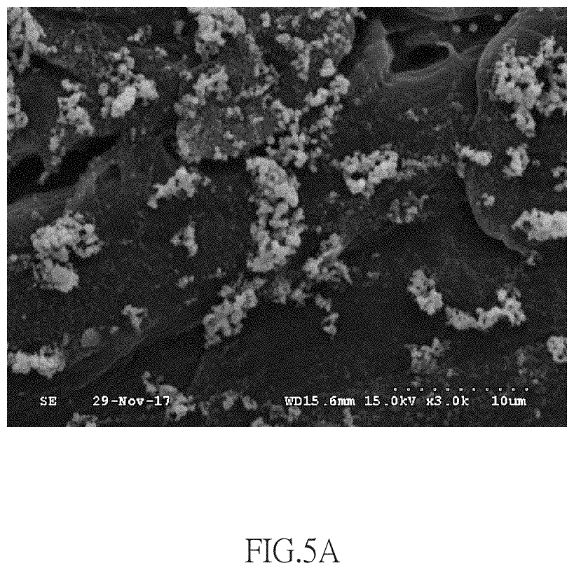

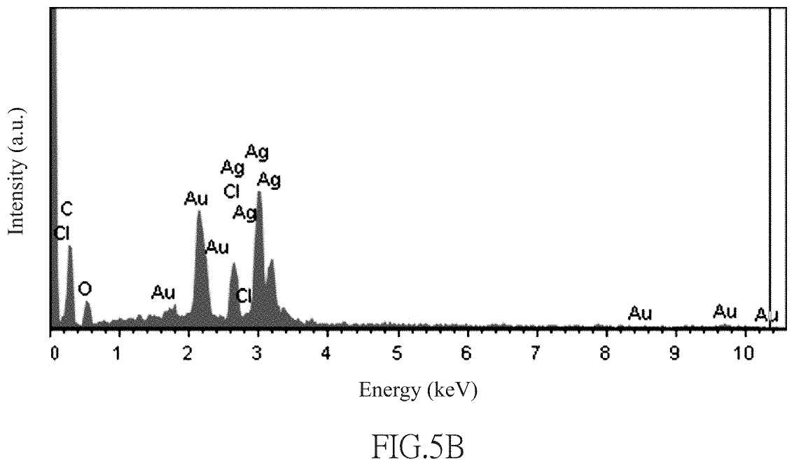

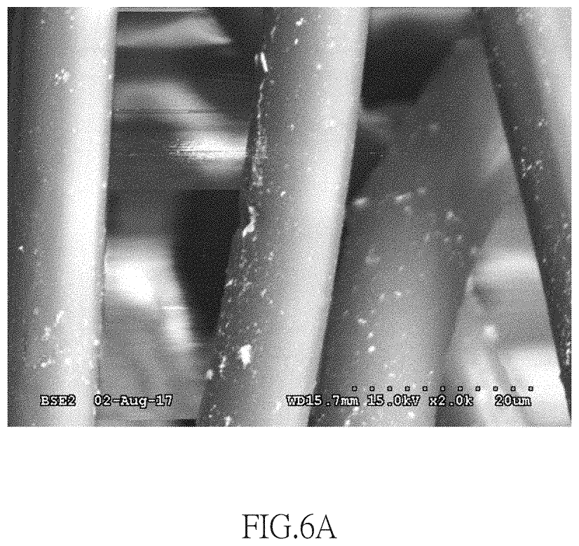

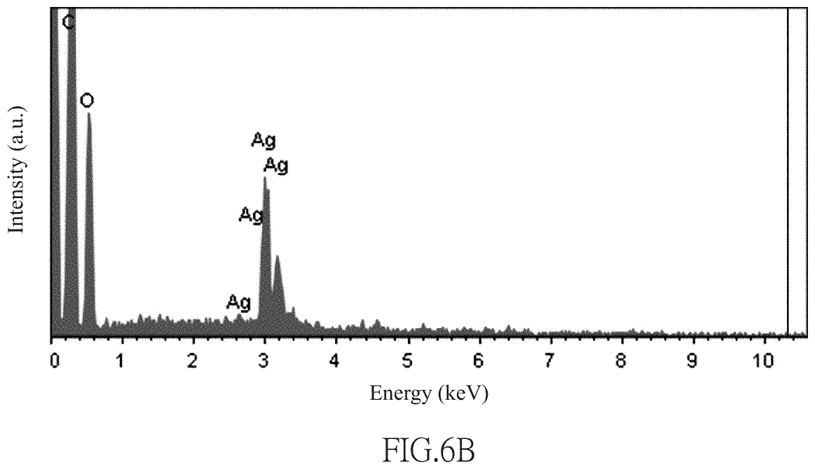

FIGS. 1A to 6A were SEM images of Fabrics A to E obtained from Examples 1 to 5 and Fabric G obtained from Example 7 in order. FIG. 1A was taken at a magnification of 1500×; FIGS. 2A to 4A were respectively taken at a magnification of 5000×; FIG. 5A was taken at a magnification of 3000×; and FIG. 6A was taken at a magnification of 2000×. As shown in FIGS. 1A to 6A, metal nanoparticles were uniformly attached to the surface of the fibers. Moreover, the particle sizes of the metal nanoparticles on the fibers comprising metal nanoparticles contained in the Fabrics A to E and Fabric G were measured, and the average particle sizes were listed in Table 1.

Table 1: kinds and average particle sizes of the metal nanoparticles of the fibers comprising metal nanoparticles obtained from Examples 1 to 5 and 7

| | Kinds of the metal | |
|---|---|---|
| | nanoparticles | |
| Example | First/Third metal | Average particle sizes (nm) |
| No. | nanoparticles | First/Third metal nanoparticles |
| Example 1 | Ag | 35.3 ± 10.2 |
| Example 2 | Au/Ag | 39.4 ± 9.3/35.7 ± 9.7 |
| Example 3 | Au/Ag | 33.4 ± 10.3/30.4 ± 7.4 |
| Example 4 | Ag | 40.8 ± 8.6 |
| Example 5 | Au/Ag | 38.5 ± 7.7/37.2 ± 10.2 |
| Example 7 | Ag | 42.4 ± 10.5 |

Analysis 2: Elemental Analysis

Each of Fabrics A to I was cut into a sample with an area of 4 cm². Next, each sample was dissolved in suitable conditions based on the kinds of the metal nanoparticles contained therein. Then, each sample was subjected to an elemental analysis by ICP-OES, thereby obtaining the concentrations of the kinds of the metal nanoparticles.

Then, based on the results of SEM combined with EDS elemental semi-quantitative analysis and mass loss analysis by thermogravimetric analysis (TGA), the spectral peak intensities of different line systems corresponding to different elements and the response values of said specific element were selected to calculate the concentration of each kind of metal nanoparticle. Subsequently, the concentration of each kind of metal nanoparticle was converted to the metal content per unit surface area of the fiber comprising metal nanoparticles, and the results were listed in Table 2.

Table 2: fiber diameters, kinds of the metal nanoparticles and the concentrations and metal content per unit surface area of the fiber comprising metal nanoparticles obtained from Examples 1 to 9

| | | | | Metal content |
|---|---|---|---|---|
| | | | | per unit |
| | | | | surface area |
| | | | | of the fiber |
| | | | Concentration | comprising |
| | Fiber | Kinds of | of the metal | metal |
| Example | diameter | the metal | nanoparticles | nanoparticles |
| No. | (μm) | nanoparticles | (ppm) | (μg/cm²) |
| Example 1 | 10.8 | Ag | 0.838 | 16.7 |
| Example 2 | 16.3 | Au | 5.038 | 12.5 |
| | | Ag | 15.14 | 37.8 |
| Example 3 | 10.1 | Au | 1.451 | 3.6 |
| | | Ag | 11.94 | 29.8 |
| Example 4 | 10.5 | Ag | 0.606 | 20.2 |
| Example 5 | 15.8 | Au | 4.071 | 10.1 |
| | | Ag | 11.739 | 29.3 |
| Example 6 | 16.1 | Ag | 0.606 | 67 |
| Example 7 | 11.9 | Ag | 0.179 | 7.16 |
| Example 8 | 11.9 | Au | 0.503 | 1.25 |
| | | Ag | 1.002 | 2.5 |
| Example 9 | 10.8 | Ag | 0.791 | 87 |

Analysis 3: Test for Antimicrobial Activity

According to the standard method JISZ 2801, each of Fabrics A to I was subjected to an antibacterial test. The test was a quantitative analysis, which mainly calculated the antibacterial rate based on the difference in the number of bacteria before and after the bacterial culture was carried out. The test strain used in this test was BCRC10451 Staphylococcus aureus. The evaluation points of the Fabric A, Fabric C to Fabric I of Examples 1, 3 to 9 were 24 hours after incubation; besides, the evaluation point of the Fabric B of Examples 2 was 6 hours after incubation. The antibacterial rates of Examples 1 to 9 were listed in Table 3.

Table 3: fiber diameters, kinds of the metal nanoparticles and the concentrations and metal content per unit surface area of the fiber comprising metal nanoparticles obtained from Examples 1 to 9

| | | | Metal content per | |
|---|---|---|---|---|
| | | | unit surface area | |
| | | | of the fiber | |
| | | Kinds of the | comprising metal | |
| Example | Kinds of | metal | nanoparticles | Antibacterial |
| No. | the fiber | nanoparticles | (μg/cm²) | rate (%) |
| Example 1 | Tetoron | Ag | 16.7 | 98.1 ± 0.7 |
| Example 2 | cellulose | Au | 12.5 | 95.3 ± 0.1 |
| | acetate | Ag | 37.8 | |
| Example 3 | PAN | Au | 3.6 | 98.7 ± 0.9 |
| | | Ag | 29.8 | |
| Example 4 | PET | Ag | 20.2 | 98.5 ± 1.2 |
| Example 5 | Rayon | Au | 10.1 | 94.8 ± 0.4 |
| | | Ag | 29.3 | |
| Example 6 | PAN | Ag | 67 | 96.4 ± 2.2 |
| Example 7 | Bamboo | Ag | 7.16 | 96.4 ± 2.2 |
| Example 8 | Bamboo | Au | 1.25 | 95.8 ± 0.3 |
| | | Ag | 2.5 | |
| Example 9 | Polyester | Ag | 87 | 97.8 ± 1.7 |

Analysis 4: Adhesive Strength Test

According to the fastness to washing of the standard method AATCC 135, each of Fabrics A to I was subjected to be repeatedly washed 20 times. All test results of Fabrics A to I were “passed.”

Discussion of the Results

Based on the experimental results of Examples 1 to 9, it demonstrates that the method of making a fiber comprising metal nanoparticles of the instant disclosure can be implemented in room temperature environment without any expensive equipment. It proves that the instant disclosure has the advantages of cost-effectiveness, low energy consumption, low heat pollution, environment-friendliness and safety.

In addition, since Examples 1 to 9 did not require the use of complicated instruments or complicated operation settings, the fibers comprising metal nanoparticles can be easily obtained. It demonstrates that the instant disclosure has the advantages of simplicity and is conducive to mass production.

Furthermore, from the raw materials of the fibers of Examples 1 to 9, the instant disclosure can be applied to various fibers, as long as the first metal ions and the second metals meet a specific range of the difference in standard reduction potential. Therefore, it has the advantages of wide application fields and more commercial implementation potential.

In addition, from the analysis results in Table 3, it demonstrates that the Fabrics A to I including the fiber comprising metal nanoparticles produced by the instant disclosure all have good antibacterial rates.

Since all of Fabrics A to I of Examples 1 to 9 passed the test of fastness to washing, it demonstrates that the fiber comprising metal nanoparticles produced by the instant disclosure has the advantage of strong bonding between the metal nanoparticles and the fiber.

Even though numerous characteristics and advantages of the instant disclosure have been set forth in the foregoing description, together with details of the structure and features of the disclosure, the disclosure is illustrative only. Changes may be made in the details, especially in matters of shape, size, and arrangement of parts within the principles of the disclosure to the full extent indicated by the broad general meaning of the terms in which the appended claims are expressed.

What is claimed is:

1. A method of making a fiber comprising metal nanoparticles, comprising steps of:
Step (A): providing a fiber and a metal salt aqueous solution comprising first metal ions;
Step (B): making the metal salt aqueous solution contact the fiber to form a fiber containing the first metal ions; and
Step (C): contacting the fiber containing the first metal ions with a second metal, and performing a reduction reaction of the first metal ions to obtain the fiber comprising metal nanoparticles, wherein the fiber comprising metal nanoparticles comprises first metal nanoparticles from a reduction of the first metal ions;
wherein a standard reduction potential of the first metal ions is greater than a standard reduction potential of an ionic state of the second metal, and a difference therebetween ranges from 0.4 volts to 4.0 volts.

2. The method of making the fiber comprising metal nanoparticles as claimed in claim 1, wherein the first metal ions comprise gold ions, platinum ions, silver ions, copper ions, iron ions, zinc ions or titanium ions.

3. The method of making the fiber comprising metal nanoparticles as claimed in claim 2, wherein a concentration of the first metal ions of the metal salt aqueous solution ranges from 1 μg/L to 90 g/L.

4. The method of making the fiber comprising metal nanoparticles as claimed in claim 1, wherein the second metal comprises magnesium metal, aluminum metal, manganese metal, titanium metal, zinc metal, iron metal, nickel metal, tin metal, copper metal or silver metal.

5. The method of making the fiber comprising metal nanoparticles as claimed in claim 1, wherein the step of making the metal salt aqueous solution contact the fiber is performed by a dipping method, a coating method, a spraying method or an automatic roll-pulling method.

6. The method of making the fiber comprising metal nanoparticles as claimed in claim 5, wherein the fiber is contacted with the metal salt aqueous solution by the dipping method for a contact time ranging from 0.1 second to 24 hours.

7. The method of making the fiber comprising metal nanoparticles as claimed in claim 1, wherein a reaction time of the reduction reaction ranges from 0.1 second to 24 hours.

8. The method of making the fiber comprising metal nanoparticles as claimed in claim 7, wherein Step (C) comprises:
Step (c1): contacting the fiber containing the first metal ions with the second metal, and performing the reduction reaction of the first metal ions to obtain a first composite fiber, wherein the first composite fiber comprises the first metal nanoparticles; and
Step (c2): leaving the first composite fiber to stand for 0.1 hour to 72 hours to obtain the fiber comprising metal nanoparticles; wherein a temperature of Step (c2) ranges from 0° C. to 120° C.

9. The method of making the fiber comprising metal nanoparticles as claimed in claim 8, wherein Step (c1) comprises:
Step (c1-1): contacting the fiber containing the first metal ions with the second metal, and performing the reduction reaction of the first metal ions to produce a mixture having second metal ions, an unreacted second metal, and the first composite fiber comprising the first metal nanoparticles; and
Step (c1-2): removing the unreacted second metal and the second metal ions from the mixture to obtain the first composite fiber.

10. The method of making the fiber comprising metal nanoparticles as claimed in claim 1, wherein an average size of the first metal nanoparticles ranges from 1 nm to 100 nm.

11. The method of making the fiber comprising metal nanoparticles as claimed in claim 1, wherein a content of the first metal nanoparticles on a surface of the fiber comprising metal nanoparticles ranges from 10 μg to 100 mg per square centimeter.

12. The method of making the fiber comprising metal nanoparticles as claimed in claim 1, wherein Step (C) comprises:
Step (c1): contacting the fiber containing the first metal ions with the second metal, and performing the reduction reaction of the first metal ions to obtain a first composite fiber, wherein the first composite fiber comprises the first metal nanoparticles;
Step (c1-b): making a metal salt aqueous solution containing third metal ions contact the first composite fiber to form a second composite fiber which contains the third metal ions, wherein the third metal ions are different from the first metal ions; and
Step (c1-c): contacting the second composite fiber with a fourth metal, and performing a reduction reaction of the third metal ions to obtain the fiber comprising metal nanoparticles, wherein the fiber comprising metal nanoparticles comprises the first metal nanoparticles and third metal nanoparticles from a reduction of the third metal ions;
wherein a standard reduction potential of the third metal ions is greater than a standard reduction potential of an ionic state of the fourth metal, and a difference therebetween ranges from 0.4 volts to 4.0 volts; the standard reduction potential of the first metal ions is greater than the standard reduction potential of the ionic state of the fourth metal.

13. The method of making the fiber comprising metal nanoparticles as claimed in claim 12, wherein the standard reduction potential of the first metal ions is greater than a standard reduction potential of the third metal ions.

14. The method of making the fiber comprising metal nanoparticles as claimed in claim 12, wherein the fourth metal is the same as the second metal.

15. The method of making the fiber comprising metal nanoparticles as claimed in claim 12, wherein an average size of the third metal nanoparticles ranges from 1 nm to 100 nm.
